(19) United States
(12) Patent Application Publication
(10) Pub. No.: US 2003/0233372 A1
(43) Pub. Date: Dec. 18, 2003

(54) Markup workflow management system

(76) Inventors: Scott Jacob Warner, Hopkinton, MA (US); James Michael Hudson, Shrewsbury, MA (US); Robert Bradford Chase, Windham, NH (US); Krishnan Padmanabhan, Framingham, MA (US); Gary Charles Kline, Medway, MA (US); David Nuri Akdikmen, Westborough, MA (US)

Correspondence Address: FISH & RICHARDSON PC, 225 FRANKLIN ST, BOSTON, MA, 02110, US

(21) Appl. No.: 10/171,172

(22) Filed: Jun. 13, 2002

(51) Int. Cl. G06F 7/00

(52) U.S. Cl. 707/104.1

(57) ABSTRACT

A computer-implemented method includes rendering a web page in a browser control in a user interface; detecting user input that selects a portion of the web page; presenting a dialog in the user interface that detects user input of a markup to the portion of the web page; and specifying a collection of users to notify of the markup. The method can also include generating a task entry that specifies the selected portion of the web page, the markup, and the collection of users to notify. The task entry can also specify one or more of the following: 1) a copy of the web page, 2) the user that provided the user input, and 3) the approximate time that the user input was detected.

### TECHNICAL FIELD

This invention relates to workflow management systems.

### BACKGROUND

New demands are pushing firms and vendors toward an integrated approach to managing documents, digital assets, and Web content. With respect to Web content, products have been developed to manage and publish the Web content for their intranet, extranet, and Internet sites. In addition to such management features as library services and administration, these products allow for content-authoring, template-design, and Web publishing workflows. In certain applications, these products also interface with application servers for personalization, scalability, and delivery.

### SUMMARY

In a general aspect of the invention, a computer-implemented method includes rendering a web page in a browser control in a user interface; detecting user input that selects a portion of the web page; presenting a dialog in the user interface that detects user input of a markup to the portion of the web page; and specifying a collection of users to notify of the markup.

Embodiments of this aspect of the invention may include one or more of the following features. The method also includes generating a task entry that specifies the selected portion of the web page, the markup, and the collection of users to notify. The task entry can also specify one or more of the following: 1) a copy of the web page, 2) the user that provided the user input, and 3) the approximate time that the user input was detected.

The method also includes saving the task entry to a database of task entries. The dialog includes a collection of HTML (Hypertext Markup Language) editing controls that detect user input of the markup. In certain embodiments, the dialog detects user input requesting a rendering of the web page that incorporates the markup. In other embodiments, the dialog renders a plurality of controls corresponding to a plurality of collections of users and wherein the dialog detects user input identifying the collection of users to notify from among the plurality of collections. For example, the plurality of controls can include buttons, while the plurality of controls includes entries in a list.

In another aspect of the invention, a computer-implemented method for markup workflow management includes the following. A web page is loaded over a first logical network connection to a web server. Markup content for the web page is loaded over a second logical network connection to a workflow server different from the web server, where the markup content specifies changes to a target portion of the web page and has a resolution status relative to a workflow model. If the resolution status indicates the markup content is unresolved, the web page is rendered with an icon superimposed on the web page proximate to the target portion. If the resolution status indicates the markup content is resolved, the web page is rendered with no alteration that indicates the markup content.

Embodiments of this aspect of the invention may include one or more of the following features. The web page is rendered with the icon superimposed includes detecting user interaction with the icon. The method also includes responding to detected user interaction with the icon by rendering a dialog containing the markup content.

In still another aspect of the invention, a computer-implemented method for markup workflow management includes maintaining a database of unresolved tasks in a workflow project, each such task having a reference to a web page, a markup to a target portion of the web page, and an indication of a party responsible for working on the task next; and rendering a task from the database of unresolved tasks in a dialog that includes a display control, such that when a user activates the display control, the web page is rendered.

Embodiments of this aspect of the invention may include one or more of the following features. The display control includes a list of unresolved tasks which, for example, indicate that the user is the party responsible for working on the tasks next. Each such task also can have a copy of the web page or can have a resolution status that indicates whether work on the task is complete.

In yet another aspect of the invention, an article includes a machine-readable storage medium that stores executable instructions to perform markup workflow management. The instructions cause a machine to maintain a database of tasks in a workflow project, each such task having an address of a web page, a copy of the web page, a markup to a target portion of the web page, a resolution status within the workflow project, and an indication of a next party responsible for resolving the task.

The method and article allow for the following advantages.

The method uses a computer to collect information about a markup to a web page, and to collect information specifying a collection of users to notify of the markup. The method integrates both markup collection and workflow features, such that the same process that collects markup information also automatically generates a task that has a status governed by a workflow model.

The method also guides the progress of a markup-related task according to the workflow model. For a given task, the automated system presents users with a collection of notification options that is tailored to the task's current progress within the workflow model.

The method stores the information about the markup independently of the storage of the web page. For example, the web page could be provided by a vendor's proprietary document management system, or in an information security environment that does not permit modifications to the web page. Even with no control over the storage of the web page itself, the invention collects markup information about the web page and provides for management of work that moves the markup toward resolution. Furthermore, the method provides for markup workflow management from a workflow server which stores workflow and task data and which is independent of the server that provides web pages. Indeed, the workflow server need not directly communicate with the server that provides web pages at all. For instance, the server that provides web pages could be in a network whose security procedures block communication with the workflow server; the method would still perform as described, as it merely requires a client to communicate with the server that provides web pages.

The method includes rendering web page to include icons that visually indicate whether portions of the web page are referenced by unresolved tasks. Each such icon corresponds to an unresolved task and is superimposed over the web page near the portion that the task references.

The method allows users to avoid redundant markup. For example, the first person to mark up a typographical error rapidly communicates that change to all other reviewers of that page. The method combines a user interface and processes for document review with a user interface and processes for communication between users about markups and related workflow.

The method captures entire discussions relevant to a single proposed revision, i.e., a task, including counter-proposals that suggest different revisions, without the need to place additional, competing task icons in the document. For one thing, this simplifies the user interface. Users who disagree with the proposed change can start a discussion at the task associated with the icon.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of a comment workflow management system.

FIG. 2 is a block diagram of logical modules in a client, a document server, and a comment workflow server.

FIG. 3 is a block diagram of a conceptual architecture for a workflow management system.

FIGS. 4A-4B are block diagrams of database tables used by a comment workflow server.

FIG. 5 is a flowchart of a workflow model and a block diagram of related entities.

FIG. 6 is a time sequence diagram of a page display process.

FIG. 7 is a time sequence diagram of a comment posting process and a task list display process.

FIGS. 8A-8B are time sequence diagrams of a task editing process.

FIG. 9 is a diagram of a comment display process.

FIGS. 10A-10D illustrate example user interface windows and dialogs at different steps in a workflow.

FIG. 10E illustrates an example rendering of a web page incorporating proposed changes.

FIGS. 11A and 11B illustrate an example comment editing dialog rendering history points and workflow information.

FIG. 12 is a block diagram of a client device, a comment workflow server device, and a document server device.

### DETAILED DESCRIPTION

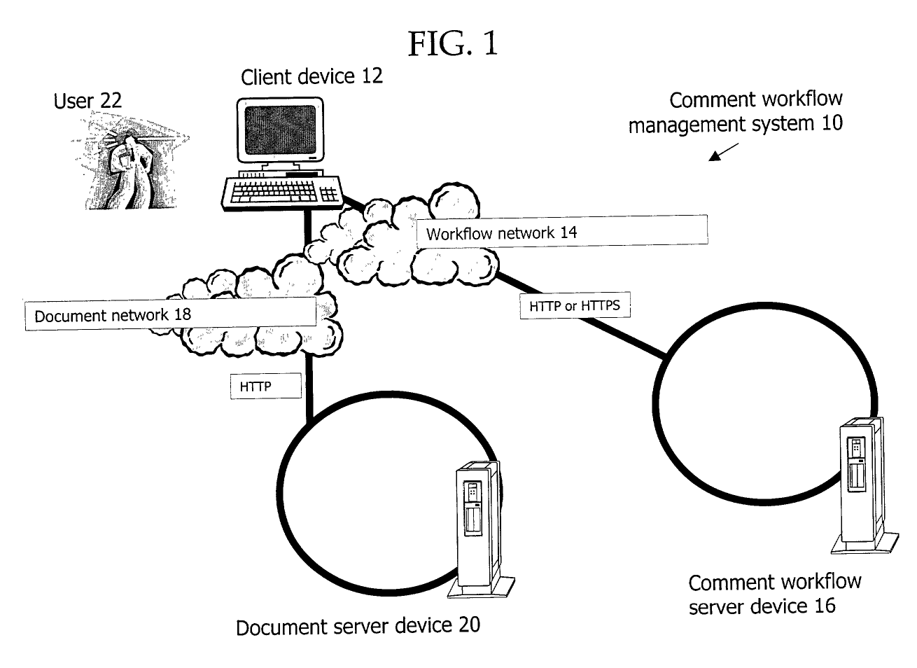

Referring to FIG. 1, broadly, and as will be explained in more detail below, a comment workflow management system 10 enables human users 22 to organize work that involves multiple tasks. Comment workflow management system 10 is automated and runs on computers. The physical components of comment workflow management system 10 include a client device 12 that allows a user 22 to communicate with a comment workflow server device 16 across a workflow network 14. Client device 12 also communicates with a web server device 20 across document network 18.

Comment workflow management system 10 manages information about the work, for example by representing a project that has collections of tasks. Comment workflow management system 10 also manages information about users 22, for example by tracking users 22 and organizing them according to roles that can represent shared centers of responsibility. Each task when it is created is unresolved. Users 22 move tasks toward resolution. With comment workflow management system 10, a first user 22 can create a task and direct it to the attention of a role. A second user 22 can browse a list of tasks that have been directed to the second user's attention via roles. The second user 22 can select a task from the list, work on the task, and either indicate that the task is complete (i.e., mark the task resolved) or direct the task to the attention of another role. A given task is repeatedly selected, worked on, and delegated until it is resolved. The metaphorical flow of “workflow” is the succession of delegations, from creation toward resolution.

Comment workflow management system 10 provides each project with a workflow model, which specifies permissible steps for tasks to follow in the project. Each task follows a path from a creation step to a resolution step. Routings define transitions between steps. A workflow model includes a creation step, a resolution step, optional intermediary steps, and routings that allow tasks to follow paths toward resolution.

In particular, comment workflow management system 10 organizes work related to document revisions, for example web pages. Each revision involves a portion of document, such as the wording of a sentence, the placement of a paragraph, a choice of typeface, and so forth. Thus, the revision can be to the content, for example text, images, or animation, as well as to the format or arrangement of the content. A markup occurs when a user attaches information to the document that describes a revision. On printed matter, markups can be placed on slips of paper attached to the original document, or can be made with a pencil directly on the document, for instance. For virtual documents, for example digital representations of documents, a markup involves capturing information that describes the revision.

Comment workflow management system 10 presents web pages to users 22 via a user interface. With comment workflow management system 10, a user 22 can view a web page and select a portion to comment on. Comment workflow management system 10 receives the user's comments and proposed revisions, collecting this information into a task. The task includes information such as the web page location, the portion selected for the comments, and a copy of the web page itself. Comment workflow management system 10 also captures the user's delegation of the task to a role, adding the task to a collection of tasks for the delegated role.

Subsequently, comment workflow management system 10 presents a responding user 22 with a list of unresolved tasks delegated to that user. To work on a task, responding user 22 can retrieve information such as the comments of the delegating user 22, the relevant web page, the portion specified by the task, and the proposed revision. When routings permit, responding user 22 can move the task between steps of the project. Moreover, in the dialog that displays the task, comment workflow management system 10 presents the user 22 with options that correspond to the routings defined within the workflow model for the task 62 in its current step.

The responding user 22 can also contribute additional information about the task. Comment workflow management system 10 presents tasks in a dialog that allows subsequent comments and revisions. Each comment is recorded along with information about the user, the time the comment was added, and the status of the task (for example, its current step within the workflow model). Over time, comment workflow management system 10 collects all such comments on a task, recording a history of the discussion and work on a given task.

When a task is resolved, comment workflow management system 10 removes it from lists of delegated tasks. When a task is not yet resolved comment workflow management system 10 includes a special browsing interface for examining the web page: comment workflow management system 10 renders the web page with an icon overlaid near the portion of the page referenced by the task.

Furthermore, when a first user is reviewing a page that a second user marks up, i.e., creates a task for, comment workflow management system 10 notifies the first user of the change. Markups are communicated between users quickly and automatically.

A user can browse the workflow history and the discussion history of a task. Comment workflow management system 10 stores “history points” which indicate transitions between steps, contributions to a discussion, and proposed alternative revisions. A user can browse the history points of a task, viewing each one together with contextual information such as the then-current step within the workflow model, or a rendering of the web page with a suggested revision performed. Comment workflow management system 10 also allows a user to preview a proposed revision before committing the task to the system.

Comment Workflow Management System

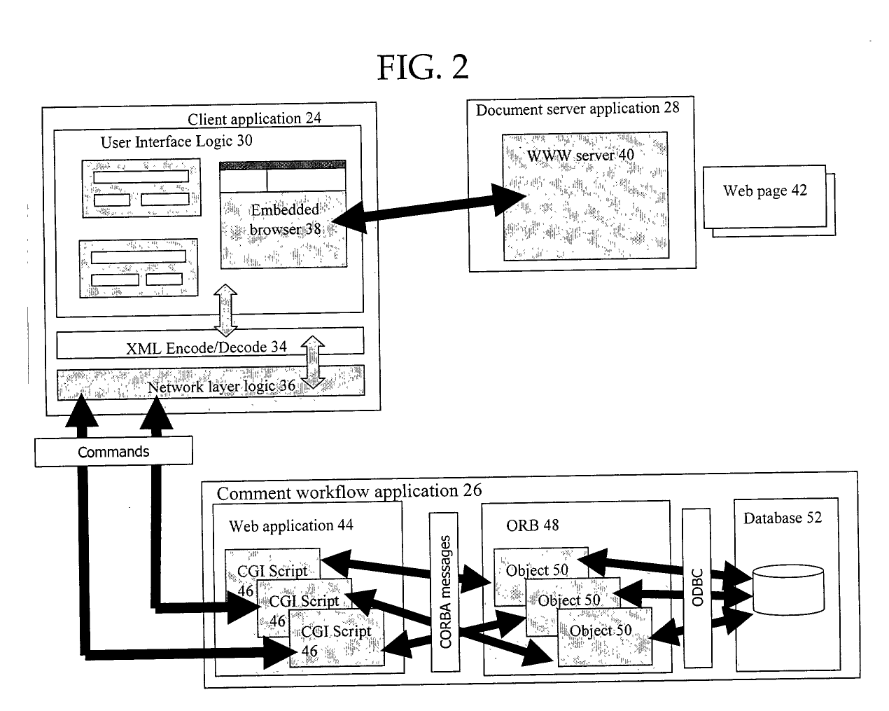

Referring now to FIG. 2, at a software level, comment workflow management system 10 includes client application 24, comment workflow application 26, and document server application 28, which are processes encoded as software instructions. Client device 12 runs a client application 24, comment workflow server device 16 runs a comment workflow application 26, and document server device 20 runs a document server application 28.

Client application 24 includes user interface logic 30, XML encode/decode logic 34, and network layer logic 36. User interface logic 30 manages the display of a user interface on client device 12 to user 22 (FIG. 1). XML encode/decode logic 34 and network layer logic 36 manage communication with comment workflow application 26. XML encode/decode logic 34 translates data in and out of XML, while network layer logic 36 manages communication via HTTP or HTTPS at the network layer. User interface logic 30 includes an embedded IE (Microsoft Internet Explorer) component 38 that renders web pages graphically on client device 12.

Document server application 28 includes a WWW (world-wide web) server 40 that serves web pages 42.

Comment workflow application 26 includes a web application 44, an ORB (object request broker) 48, and a database 52. Web application 44 includes CGI (Common Gateway Interface) scripts 46. ORB 48 has a collection of objects 50. ORB 48 complies with CORBA (Common Object Request Broker Architecture) standards. CORBA is a widely used standardization scheme for object interfaces.

Conceptual Model

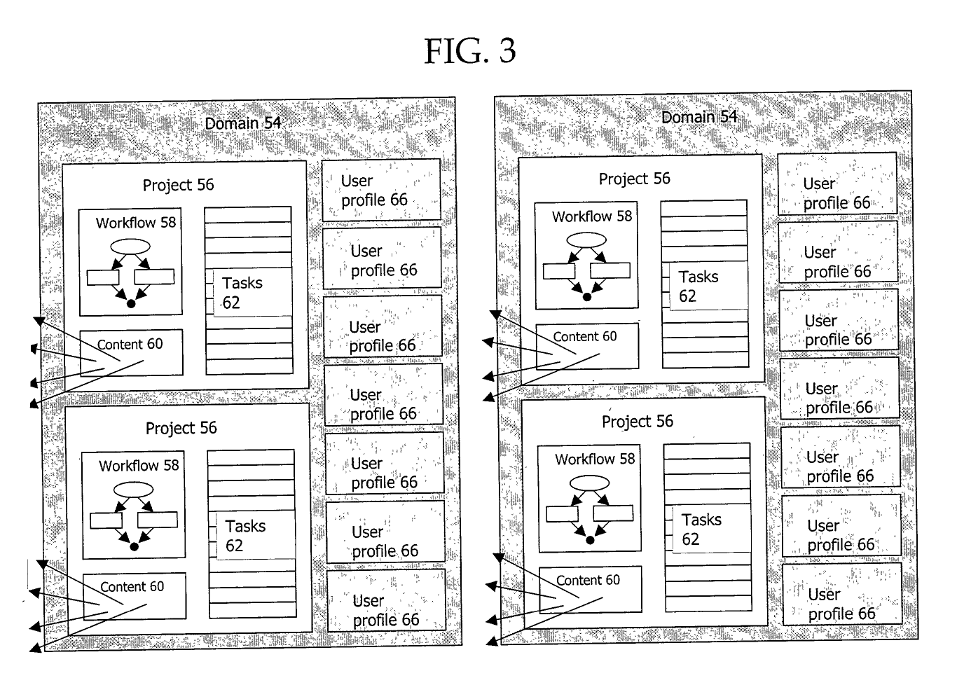

Referring now to FIG. 3, comment workflow management system 10 can track multiple projects 56, organizing them according to domains 54. A domain 54 is an organizational convenience for users 22 that allows them to group projects 56 as needed. For example, a freelance web production company might use comment workflow management system 10 to group projects 56 into domains 54 such that each domain 54 represents a customer and each project 56 represents a different development contract for the customer. A different collection of users 22, for example a university, could define domains 56 that correspond to academic departments.

In the conceptual model of comment workflow management system 10, domain 54 is the broadest category. Each domain 54 includes one or more projects 56 and one or more user profiles 66. In turn, each project 56 includes a workflow model 58, a collection of content references 60, and a collection of tasks 62. A profile 66 represents a specific user 22.

Comment workflow management system 10 defines a workflow model 58 as a set of steps and associated routing information. Every task 62 must be processed as defined in the workflow 58, proceeding from step to step. When a task 62 arrives at a given step, comment workflow management system 10 considers the task 62 to have been delegated to each of a set of users 22, as identified by the corresponding user profiles 66.

A user 22 can span domains 54. In other words, a user 22 can be identified by a first profile 66 in one domain 54 and by a second profile 66 in a different domain 54.

Content references 60 specify sources for documents such as web pages 42. One example of a content reference 60 specifying a source is by citing a URL (Uniform Resource Locator). Content references 60 can also specify hierarchical structure within the sources, for example directory structures in a filing system, or virtual directories within a URL.

Database

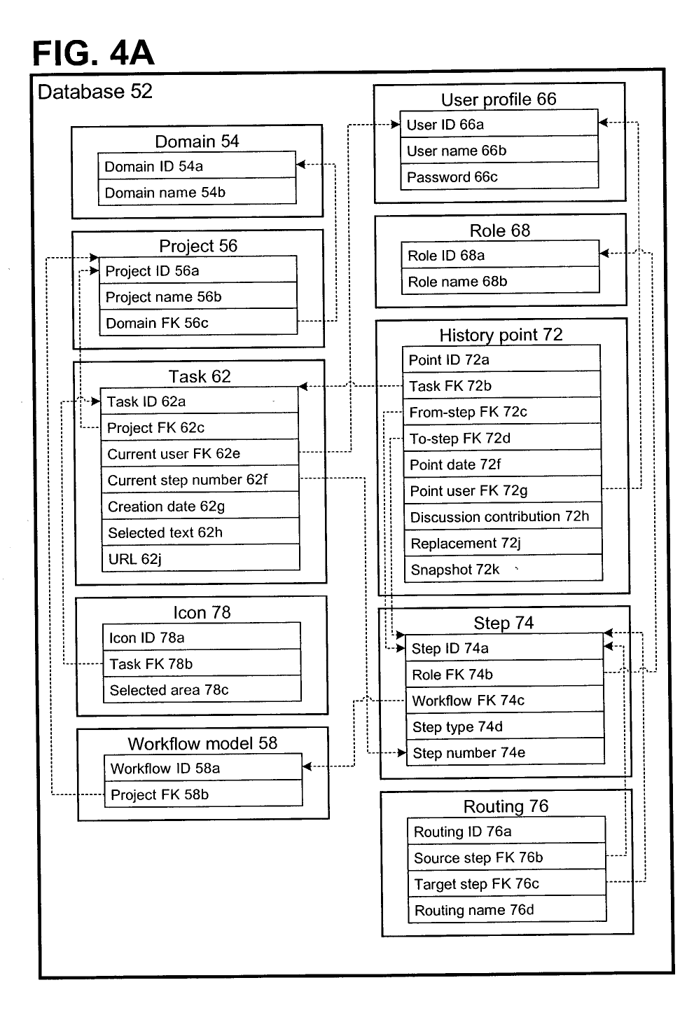

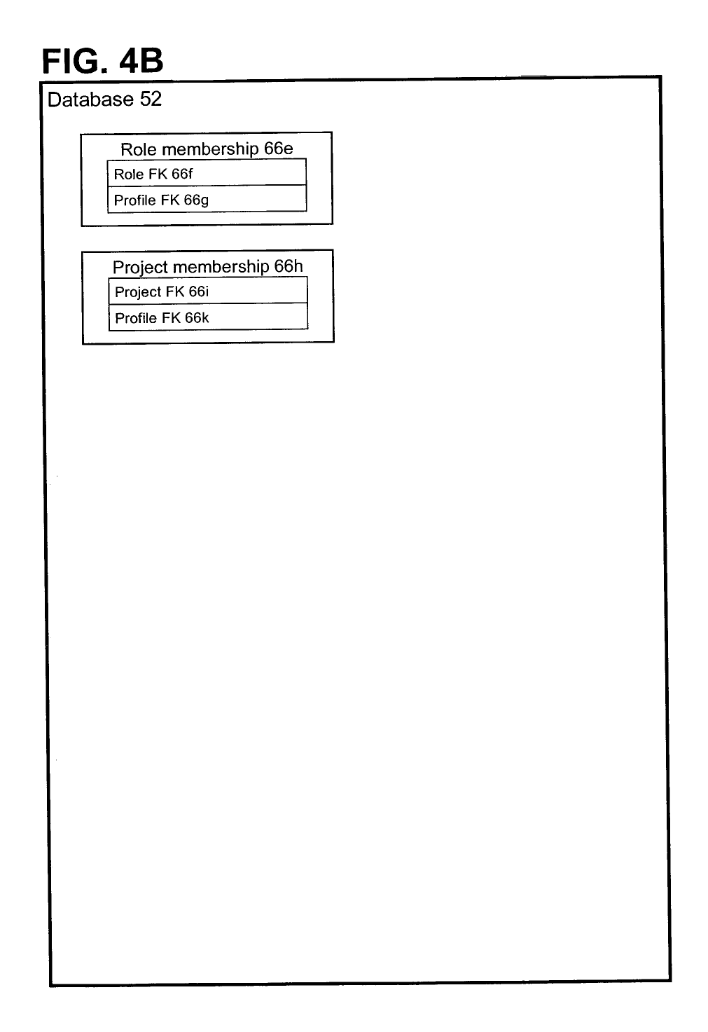

Referring now to FIGS. 4A and 4B, database 52 is a source of data that is accessible via ODBC (Open DataBase Connectivity, which is an interface standard for databases). Database 52 includes tables for domain 54, project 56, workflow model 58, task 62, user profile 66, role 68, history point 72, and icon record 78.

In database 52, some attributes of a conceptual entity may be connected indirectly to the record that most closely corresponds to the conceptual entity. For example, from one perspective, a discussion of a task is an attribute of the task, but in this embodiment, database 52 does not store discussions directly in task records 62. Instead, database 52 represents such discussions as collections of individual contributions by user profiles, where each contribution is stored in a history point, and each history point is connected to a task via a task reference, as will be explained. In general, for simplicity, this discussion uses terms such as domain 54, project 56, workflow model 58, task 62, user profile 66, role 68, history point 72, and icon record 78, to refer interchangeably to the corresponding table in database 52 or to the conceptual entity that the table represents.

Project

Project 56 includes fields for project ID 56a, project name 56b, and domain FK (foreign key) 56c. Project ID 56a uniquely identifies records of project 56 relative to one another. Project name 56b stores a caption for project 56 to present to a user 22. Domain FK 56c associates project 56 with domain 54 by referencing domain ID 54a.

Each project 56 also has a collection of content references 60 (shown in FIG. 3) and a collection of tasks 62.

Domain

Domain 54 includes fields for domain ID 54a and domain name 54b. Domain ID 54a uniquely identifies records of domain 54 relative to one another. Domain name 54b stores a caption for domain 54 to present to a user 22.

Workflow Model

Broadly, workflow model 58 represents a state machine that governs the progress of tasks 62 from creation to resolution.

Workflow model 58 includes fields for workflow ID 58a and project FK 58c. Workflow ID 58a uniquely identifies records of workflow model 58 relative to one another. Project FK 58c specifies the project 56 associated with each workflow model 58. Specifically, project FK 58c references project ID 56a.

Each workflow model 58 has at least a creation step associated with it; it can also have a terminal step, one or more intermediary steps, and a collection of routings.

A single routing 76 can both depart creation step 74 and arrive at terminus step 74. More commonly, though, the endeavor modeled by workflow model 58 is more complex. For example, web-page markup work often has intermediary stages devoted to review and approval. Thus, workflow model 58 often represents a more complicated series of transitions, including one or more intermediary steps 74.

A workflow model has either zero or one terminus step 74. A workflow model cannot have more than one terminus step 74.

Step

A step 74 describes a permissible state of a task 62 within a workflow model 58.

Each step 74 includes fields for step ID 74a, role FK 74b, workflow FK 74c, step type 74d, and step number 74e. Step ID 74a uniquely identifies records of step 74 relative to one another. Role FK 74b specifies a role 68 for step 74 by referencing role ID 68a. Every intermediary-stage step 74 is associated with some role 68. A tenninus step has no associated role, and the role associated with the creation step is predefined. Workflow FK 74c specifies a workflow model 58 for step 74 by referencing workflow ID 58a.

Step type 74d indicates whether a given step is a creation step, a terminus step, or an intermediary. A creation step 74 represents a starting point for a task 62. A terminus step 74 represents a resolution for a task 62. Each valid workflow model 58 has at least one creation step 74 and zero or one terminus step 74.

Step number 74e indicates the ordinal position of step 74 within workflow model 58. Within a given workflow model 58, each step 74 has a distinct value for step number 74e.

To label a given step 74 for a user 22, comment workflow management system 10 uses the caption for the associated role 68.

Routing

A routing 76 represents a directed transition that a task 62 is permitted to make from a source step 74 to a target step 74.

Each routing 76 includes fields for a routing ID 76a, a source step FK 76b, a target step FK 76c, and a routing name 76d. Routing ID 76a uniquely identifies records of routing 76 relative to one another. Source step FK 76b specifies source step 74 by referencing step ID 74a, while target step FK 76c specifies target step 74 by referencing step ID 74a. Routing name 76d stores a caption for routing 76, for instance to present to a user 22 in the user interface.

For a given step 74, the routings 76 that depart from it must have distinct names, i.e., distinct values for routing name 76d. This distinctiveness allows comment workflow management system 10 to present user 22 with recognizably different names for controls, when user 22 is choosing among possible routings for a task departing the given step.

Role

A role 68 represents a collection of one or more users 22 that have a responsibility in common. For example, one role 68 could represent a group responsible for graphic design, while another role 68 represents a group responsible for writing copy. A given role 68 can be associated with more than one user profile 66; likewise, a given user profile 66 can be associated with more than one role 68.

Role 68 includes fields for role ID 68a and role name 68b. Role ID 68a uniquely identifies records of role 68 relative to one another. Role name 68b stores a caption for role 68 to present to user 22. Each Role 68 has a collection of user profiles 66, which identify the users 22 to which a task can be delegated when it is in a particular step 74 of a workflow model 58.

Each project 56 includes a special, predefined role for user profiles 66 who can create tasks. This role is associated with the creation step of the workflow model.

User Profile

Comment workflow management system 10 represents a user 22 internally via a user profile 66. Conceptually, a user profile 66 is like a user account. A given user 22 has a user name (stored in user name 66b) and login password (stored in password 66c).

User profile 66 also includes user ID 66a, which uniquely identifies records of user profile 66 relative to one another.

Each user profile 66 has a collection of role memberships 66e. A role membership 66e joins a user profile 66 to a role 68. A given user profile 66 has one role membership 66e for each role 68 that the user profile 66 belongs to. Each role membership 66e includes a role FK 66f, which references role ID 68a, and a profile FK 66g, which references user ID 66a.

Each user profile 66 also has a collection of project memberships 66h. A project membership 66h joins a user profile 66 to a project 56. A given user profile 66 has one project memberships 66h for each project 56 that the user profile 66 belongs to. Each project membership 66h includes a project FK 66i, which references project ID 56a, and a profile FK 66k, which references user ID 66a.

Task

A task represents an amount of work to be done within a project 56. For example, a task 62 can represent a comment that a user 22 makes regarding a web page 42, including the commentary, the current user profile 66, a timestamp, the proposed change, and a copy of the web page 42 as it existed when the comment was made. Task 62 includes state information describing the progress of task 62 toward resolution within workflow model 58, for example the step number 74e of the step 74 that task 62 is currently affiliated with.

Each task 62 includes fields for task ID 62a, project FK 62c, current user FK 62e, current step number 62f, creation date 62g, selected text 62h, and URL 62j. Task ID 62a uniquely identifies records of task 62 relative to one another. Project FK 62c specifies a project 56 for task 62, referencing project ID 56a.

State information of task 62 can include a single user profile 66 affiliated with task 62, specified by current user FK 62e referencing user ID 66a. For example, it is possible for several user profiles 66 to share a role 68 to which a given task 62 is delegated. Current user FK 62e can identify a single user profile 66 that has claimed responsibility for task 62.

Current step number 62f affiliates task 62 with a current step 74 by referencing step number 74e. Creation date 62g indicates when task 62 was created.

Selected text 62h stores a copy of the portion of the web page with which task 62 is associated. URL 62j stores an address for the web page.

History Point

A task has a collection of history points 72. Broadly, history points 72 store information that describes the task's evolution over time, for example as work is performed that moves it toward resolution. In particular, a history point 72 can describe a transition between steps of a workflow model. Also, history points 72 capture contributions to a discussion among users. Each history point can store a contribution. Furthermore, history points 72 can store counterproposals that responding users may provide, recommending different revisions than the revision originally proposed for the associated task.

Each history point 72 includes fields for point ID 72a, task FK 72b, from-step FK 62c, to-step FK 62d, point type 62e, point date 62f, point user FK 72g, discussion contribution 72h, replacement 72j, and snapshot 72k. Point ID 72a uniquely identifies records of history point 72 relative to one another. Task FK 72b associates history point 72 with a task record by referencing task ID 62a. From-step FK 62c and To-step FK 62d indicate steps 74 that associated task 62 transitions between, each referencing step ID 74a. Point date 62f indicates a time of creation for history point 72. Point user FK 72g indicates the user profile 66 that performed the activity represented by history point 72. Discussion contribution 72h stores text of a user's contribution to a discussion of the associated task 62. Replacement 72j stores an HTML characterization of a proposed replacement for the portion of the web page referenced by associated task 62. Snapshot 72k stores a copy of the reference web page as it existed at the time history point 72 is generated.

Icon

Each icon record 78 identifies the portion in the web page to which the task 62 applies. Each icon record 78 includes fields for icon ID 78a, which uniquely identifies the icon, task FK 78b, which identifies the task with which this icon is associated, and selected area 78c, which is a copy of the portion of the web page with which this task is associated.

Tasklist

A tasklist 82 is a dynamic collection of unresolved tasks 62 associated with a user profile 66. A task 62 is added to a profile's tasklist 82 when the task is delegated to the user profile 66, whether directly or via a role 68. A task 62 is removed from all tasklists 82 that contain it when the task 62 becomes resolved. Also, a task 62 is removed from the tasklist 82 of a given profile 66 when it is delegated elsewhere, for example delegated to a role 68 that does not contain the given profile 66, or delegated to a specific, other user profile 66 by being claimed via the current user FK 62e reference.

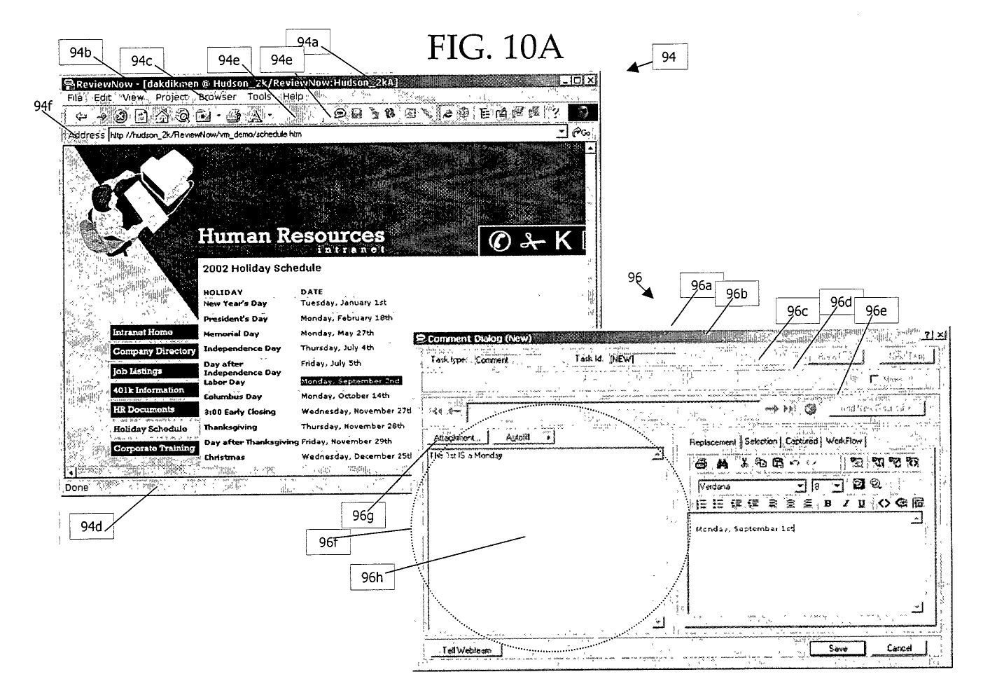

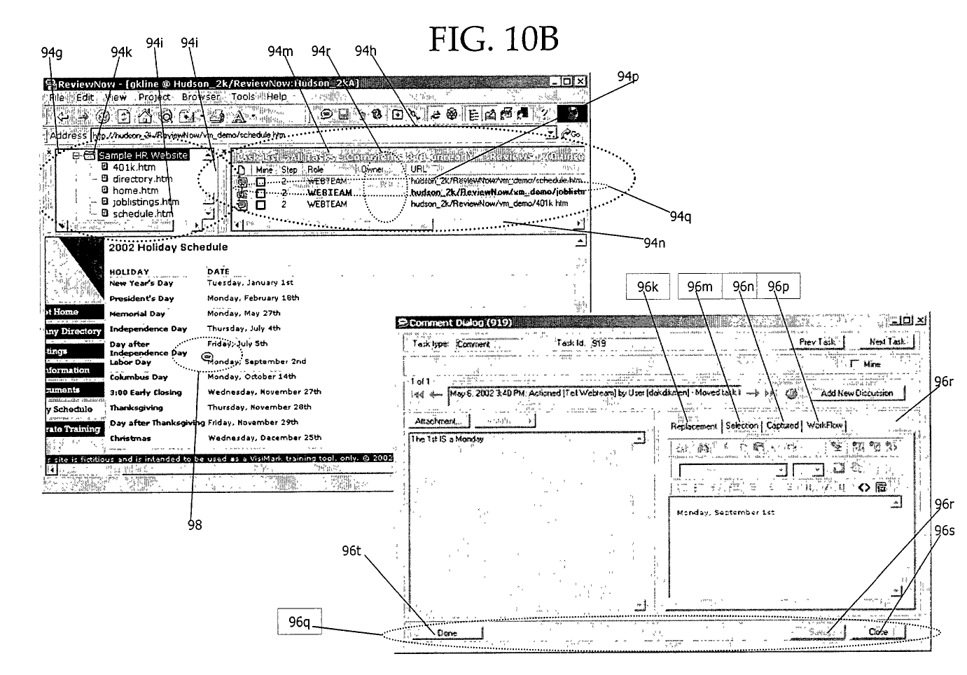

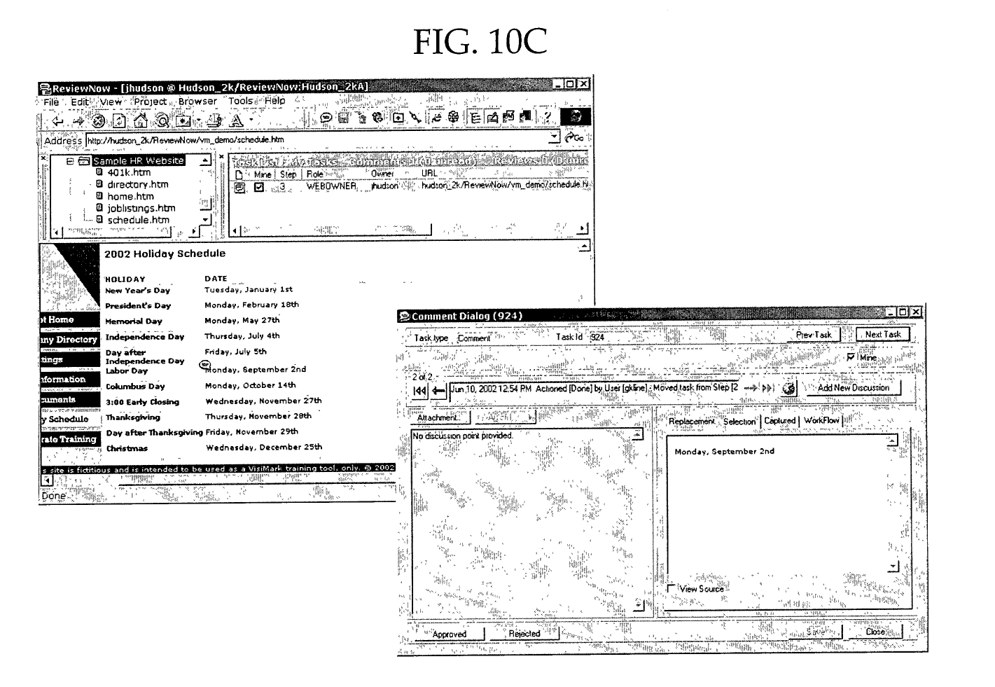

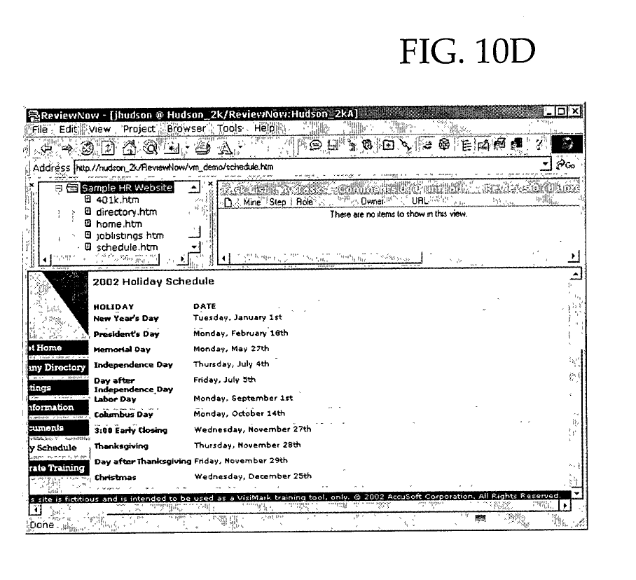

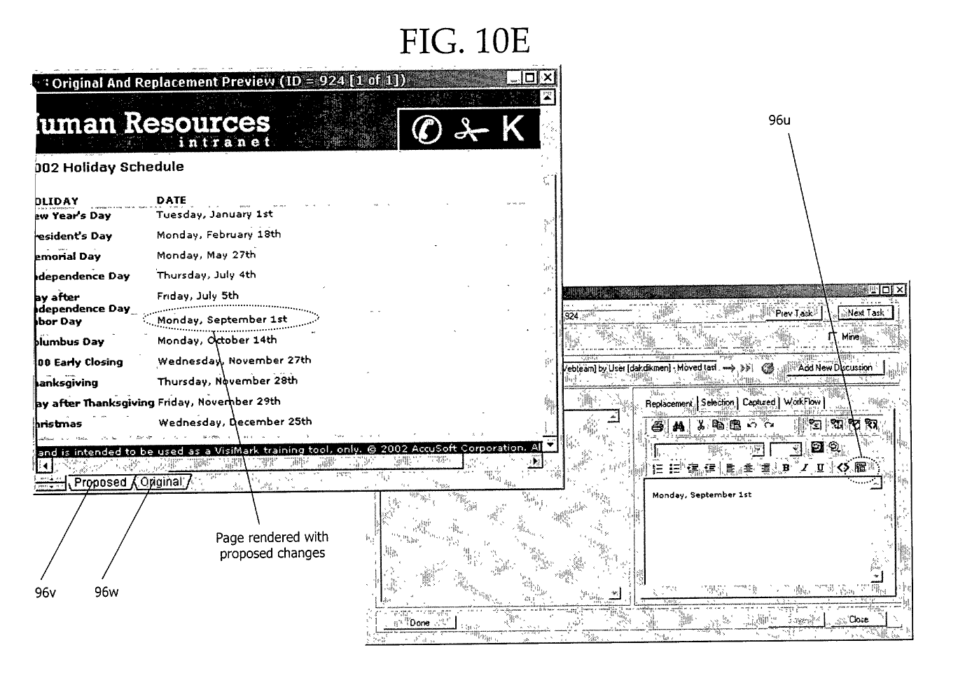

FIG. 10B shows an example rendering of a tasklist 82 in a user interface.

Workflow Model Example

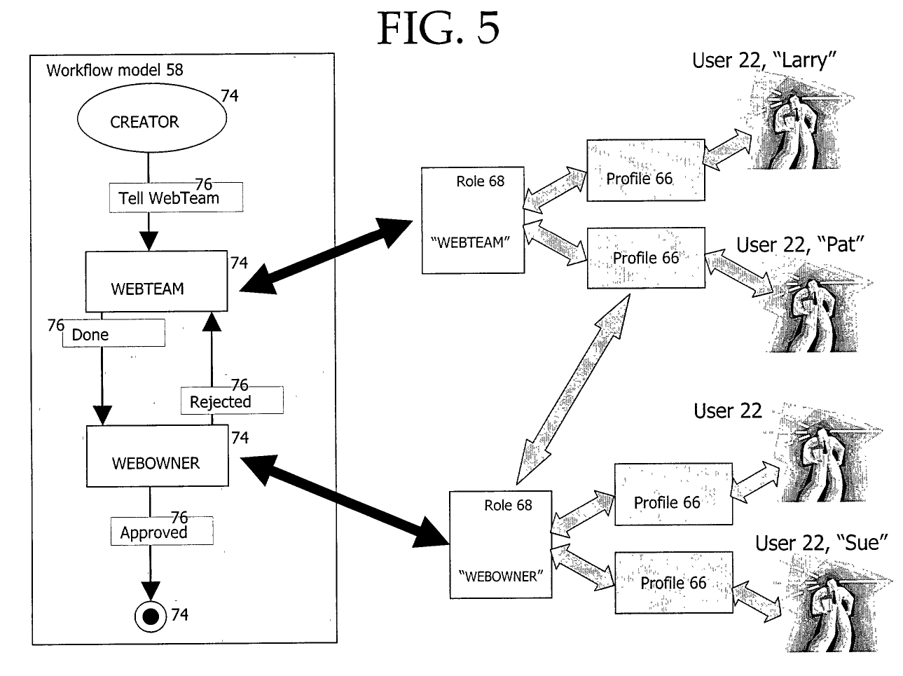

Referring now to FIG. 5, this description follows an example workflow model 58, illustrated here as a graph, that includes four steps 74. One of the steps is a creation, one is a terminus, and two are intermediary. Tasks 62 for this workflow model 58 originate at creation step 74, labeled “CREATOR”. Tasks 62 progress through steps 74 labeled “WEBTEAM” and “WEBOWNER”. In this example, the terminus step 74 has no text label. Since labels on steps 74 are stored in the role name 68a (shown in FIG. 4A) of the role 68 that corresponds to each step 74, a terminus step 74 need not have a corresponding role 68; for one thing, tasks 62 at a terminus step 74 are resolved and thus need no further delegation.

Workflow model 58 also includes routings 76 that define permissible paths of progress between steps 74. The labels “Tell WebTeam”, “Done”, “Rejected”, and “Approved” are stored in routing names 76d on the corresponding routings 76.

In operation of workflow model 58, client application 24 creates a task 62, initially associated with creation step 74. Client application 24 provides a dialog in a user interface for a creating user 22 to populate the task 62 and to choose a routing 76 for it. The creating user 22 selects a control on the dialog corresponding to routing 76 labeled “Tell WebTeam”. If any required information is missing, client application 24 sets the required information to default values. Then, comment workflow management system 10 transfers the task 62 to the step 74 labeled “WEBTEAM”.

At this point, the task 62 appears on the tasklists 82 of any user profile 66 that belongs to the role 68 associated with the step 74 labeled “WEBTEAM”. The role FK 74b (FIG. 4A) on step 74 specifies the association of step 74 with role 68. A user profile 66 belongs to a role 68 if a role membership 66e is present that specifies both the user profile 66 and the role 68.

Next, a user 22 with a qualifying user profile 66, for example the user 22 labeled “Larry”, edits the task 62 using an editing dialog. The dialog includes a control, for example a button, corresponding to the routing 76 labeled “Done”. Larry clicks the button to indicate that he has resolved the task 62. Comment workflow management system 10 removes the resolved task 62 from the tasklists 82 of the “WEBTEAM” and transfers the task 62 along the routing 76 labeled “Done”. The task 62 arrives at the step 74 labeled “WEBOWNER”.

At this point, task 62 appears on the tasklists 82 of all user profiles 66 belonging to the role 68 associated with the step 74 labeled “WEBOWNER”. For example, user 22 labeled “Sue” is associated with this step 74. Sue can edit the task 62 from her tasklist 82. Client application 24 presents a dialog that includes controls corresponding to each of the routings 76 available to task 62 at this point: namely, the routing 76 labeled “Rejected” and the routing 76 labeled “Approved”. Sue can activate the control for “Approved” to indicate that she has reviewed and approved the changes made by Larry during the step 74 labeled “WEBOWNER”. In this case, comment workflow management system would transfer task 62 along the routing 76 labeled “Approved”. Task 62 would arrive at terminus step 74. Alternatively, Sue can activate the control for “Rejected” to indicate that more work is needed. In this case, comment workflow management system 10 would transfer the task 62 along the routing 76 labeled “Rejected” back to the step 74 labeled “WEBTEAM”. In either case, the task 62 would disappear from the tasklists 82 of “WEBOWNER” user profiles 66.

When the task 62 reaches terminus step 74, comment workflow management system 10 considers the task 62 resolved.

Client Application

Client application 24 includes processes that allow a user 22 to participate in workflow within comment workflow management system 10. Client application 24 uses a login process, a page display process 84, a comment posting process 86, a task list display process 88, a task editing process 90, and a comment display process 92.

User 22 interacts with client application 24 in a session. The login process initiates a session as user 22 chooses a user profile 66, for instance by providing a username and password that match user name 66b and password 66c, respectively (shown in FIG. 4A). Login process also associates the current session with a current project 56 in a current domain 54.

Page Display Process

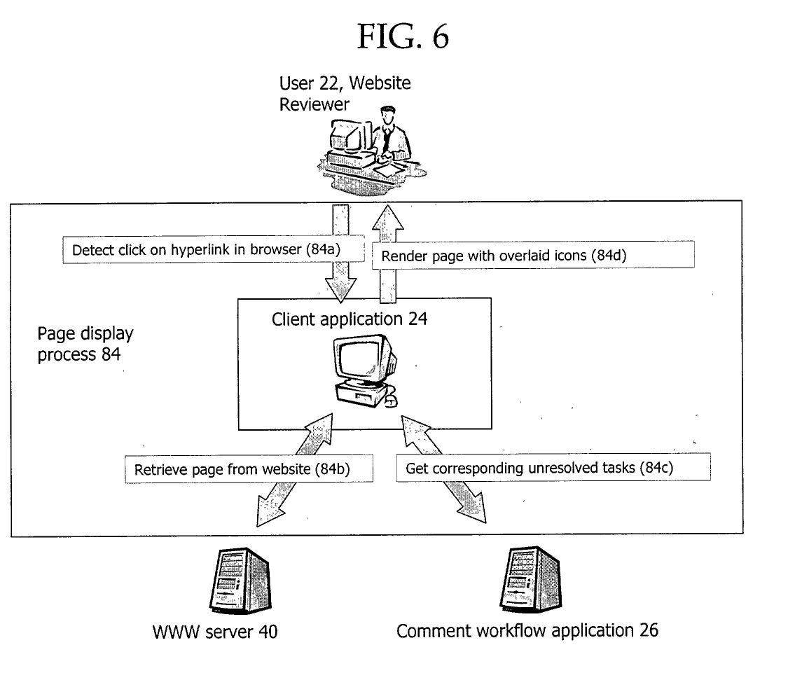

Referring now to FIG. 6, page display process 84 operates after a user 22 has logged in to a client application 24. UI logic 30 presents a user interface to user 22 and mediates between page display process 84 and actions by user 22.

Page display process 84 detects a request by user 22 to view a web page 42, for instance by detecting a click on a hyperlink in a web browser, where the hyperlink specifies the URL of web page 42 served by WWW server 40 (step 84a). Page display process 84 sends an HTTP request to WWW server 40 for web page 42 (step 84b), for instance using document network 18. Page display process 84 retrieves tasks 62 associated with web page 42 from comment workflow application 26 (step 84c), using workflow network 14. In particular, page display process 84 sends an HTTP request to a CGI script 46. Within comment workflow application 26, CGI script 46 sends a CORBA message to a corresponding object 50, which queries database 52 and returns the requested tasks 62. Only tasks 62 that are unresolved are selected by the query. A task is associated with a web page when the URL 62j of a task 62 specifies the web page.

Page display process 84 renders web page 42 overlaid with icon images 98 representing icon records 78 (step 84d). Each such icon image 98 is a graphical representation of a task 62 that pertains to web page 42. Moreover, icon image 98 is positioned on web page near the portion of web page 42 referenced by the corresponding task 62. A task 62 references a portion of a web page 42 in selected area 78c of an icon record 78 associated with the task.

Web page 42 may be dynamic. In particular, web page 42 may have changed in the interim since a task 62 referenced a portion of the web page. If the referenced portion of web page 42 has changed or is missing, page display process 84 renders the corresponding icon record 78 as an “orphan” in a default location, for instance in the upper-left corner of web page 42. Page display process 84 can also change the visual style of icon image 98, for instance its color, to indicate orphan status.

If comment workflow management system 10 does not have any tasks 62 corresponding to web page 42, page display process 84 renders web page 42 without any overlay.

Page display process 84 automatically refreshes its collection of unresolved tasks 62 associated with web page 42 and re-renders the page (i.e., repeats steps 84c and 84d) on an ongoing basis. Page display process 84 maintains a timer that indicates the amount of time elapsed since tasks 62 of web page 42 were last retrieved from comment workflow application 26. If user 22 selects a new web page 42 or refreshes it, page display process 84 resets the timer. If the timer reaches a predetermined limit, for example 60 seconds, indicating that no tasks have been retrieved in that time, page display process 84 contacts comment workflow application 26 to refresh its collection of tasks 62 is up-to-date. If, for example, another user has added an unresolved task 62 to web page 42 in the interval since page display process 84 last retrieved tasks 62, page display process 84 incorporates the new task into its collection. Similarly, if a task in the collection is newly resolved, page display process 84 removes the resolved task from its collection. Thus, page display process 84 ensures that changes to tasks 62 at comment workflow application 26 propagate quickly to client application 24. For example, for a timer with a 60-second limit, page display process 84 ensures that the average delay for a changed task to propagate is approximately 30 seconds, or even less if user 22 causes more frequent retrievals.

One result of rapid propagation of task changes to client application 24 is that user 22 receives highly current information about which portions of web page 22 have already been marked up by other users. This reduces the likelihood that user 22 will propose a separate markup that is redundant to or in competition with another user's existing markup. As will be explained in more detail with regard to FIGS. 10A-10D, if, for a given portion of web page 42 having a task 62 already proposed, user 22 wishes to propose a different markup, user 22 can contribute to a discussion of the existing task 62 rather than create a new one. In this fashion, comment workflow management system 10 guides users to consolidate their competing (but related) editorial input under a single rubric. In particular, when mutually-exclusive markup proposals exist, only one which will be adopted, they each can be represented in comment workflow management system 10 by a single task 62.

Page display process 84 uses embedded browser 38 of client application 24 to render web page 42.

Comment Posting Process

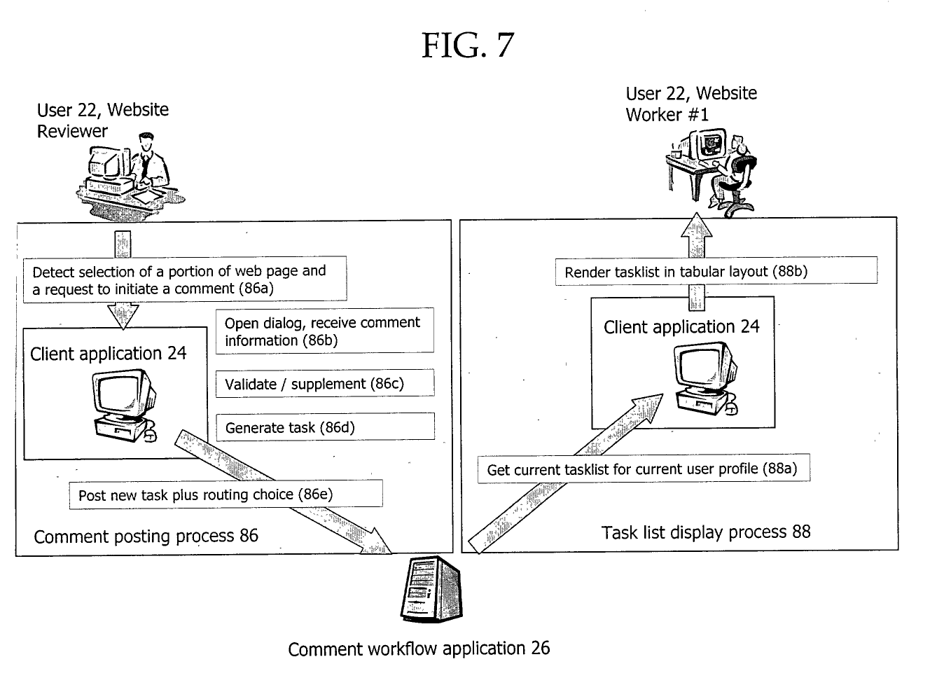

Referring now to FIG. 7, comment posting process 86 operates after a user 22 has logged in to a client application 24 and loaded a web page 42, for instance using page display process 84. UI logic 30 presents a user interface to user 22 and mediates between comment posting process 86 and actions by user 22. The current user session is associated with a current project 56, which includes a workflow model 58.

Comment posting process 86 detects that user 22 selects a portion of web page 42 and requests to enter a markup (step 86a). For example, user 22 can click and drag a mouse to highlight a block of rendered text, then activate a control that requests a markup. The control is a menu option on a context menu opened by right-clicking on the highlighted portion, for instance. Comment posting process 86 captures the HTML source for the block of rendered text.

Instead of highlighting text, user 22 can select a hyperlink or image. Thus, comment posting process 86 captures the HTML source for the selected portion, whether it is text, hyperlink, or image.

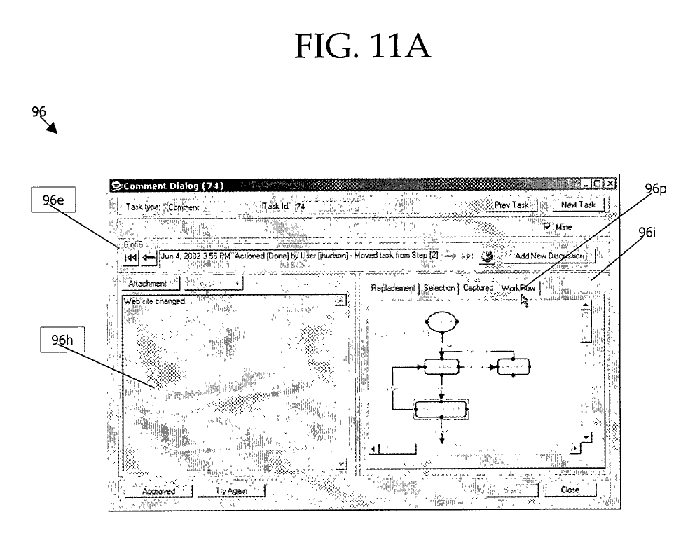

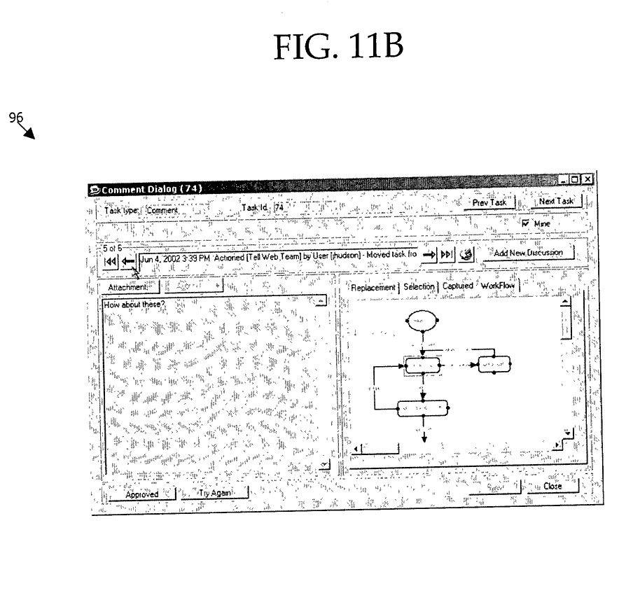

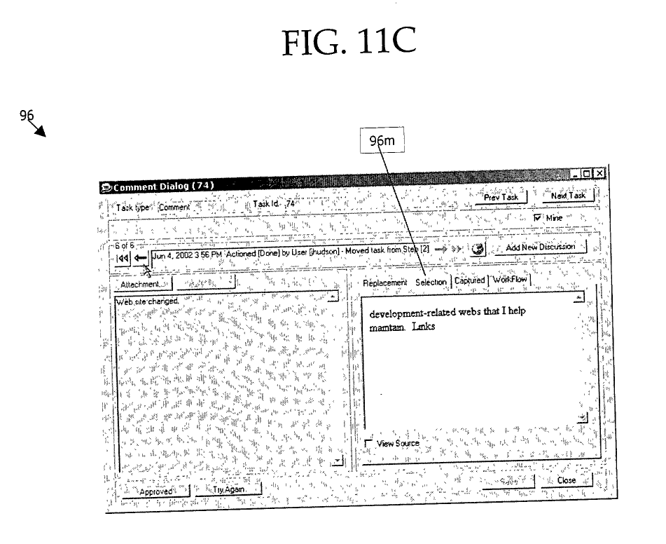

Comment posting process 86 presents user 22 with a dialog to receive input describing a comment to be stored as a task 62. The dialog includes controls (for example, buttons) corresponding to routings 76 that describe transitions out of the creation step 74 for workflow model 58. An example dialog is described in more detail with regard to FIGS. 10A-10E and FIGS. 11A-11B.

User 22 can enter a reason for the comment into a text box associated with discussion contribution 72h. User 22 can provide sample modifications to web page, using an HTML editor. The sample modifications are received in a control associated with replacement 72j. User 22 can preview what the modifications will look like by activating a button, which causes UI logic to render the web page with the modification incorporated. The web page is rendered in a window with tabs for both the original web page and the proposed modifications, allowing user 22 to compare the two versions and to verify that the proposed modifications are acceptable.

Comment posting process 86 waits for user 22 to dismiss the dialog. User 22 can cancel the dialog for the task, for example if the previewed modification is not acceptable to the user. If the current task is a new task and the user cancels the dialog, comment posting process 86 terminates without creating the task 62 or related records in database 52. If the current task is not a new task and the user cancels the dialog, comment posting process 86 terminates without modifying the task 62 or related records in database 52.

If user 22 dismisses but does not cancel the dialog, comment posting process 86 validates and supplements the information to ensure that the information describes a valid task 62 (step 86c). For example, if more than one routing 76 is available for the new task 62, user 22 must choose a routing 76 using the associated controls. If user 22 does not choose a routing 76, comment posting process 86 does not transition the task, even if there is only one available routing 76. This allows user 22 to update a task incrementally without incurring a transition. When user 22 does select a transition, comment posting process 86 supplements the user input as needed according to default values, forming a complete set of information necessary for the task 62 to transition.

Comment posting process 86 generates a task 62 for the information (step 86d). Project FIG. 62c receives a reference to the current project 56, URL 62j indicates the URL of web page 42, and selected text 62h and selected area 78c indicate the text and location, respectively, of the portion of web page 42 selected for the task. Comment posting process 86 generates a history point 72 describing the creation of the task 62, specifying the current user profile 66 in point user FK 72g and the current time in point date 72f, and storing a copy of web page 42 in snapshot 72k. Replacement 72j stores the proposed revision, if any. To-step FK 72d receives the target step 74 associated with the chosen routing 76.

Comment posting process 86 associates the history point 72 with the task 62. Similarly, comment posting process 86 creates icon record 78 and associates it with the task, as well.

Comment posting process 86 transmits the new task 62 and associated history point 72 to comment workflow application 26 for storage in database 52 (step 86e). Comment posting process 86 confirms the success of the posting transaction before completing.

If the new task is unresolved, i.e., not at a terminus step 74, the task appears in the tasklist 82 for each user profile 66 associated with the task's current step.

Task List Display Process

Task list display process 88 operates after a user 22 has logged in to a client application 24. UI logic 30 presents a user interface to user 22 and mediates between task list display process 88 and actions by user 22. The current user session is associated with a current project 56, which includes a collection of tasks 62.

Task list display process 88 retrieves a tasklist 82 for the current user profile 66 from comment workflow application 26 (step 88a). Tasklist 82 includes tasks 62 affiliated with steps 74 that, in turn, are either directly affiliated with the current user profile 66 or are affiliated with a role 68 that includes the current user profile 66. Moreover, the tasks 62 are associated with the current project 56 and are unresolved, i.e., not at a terminus step 74 in the current workflow model 48.

Task list display process 88 renders tasklist 82 in a panel of a window presented by UI logic 30 (step 88b). An example panel is shown in FIGS. 10A-10D. The panel includes a title bar along the upper edge, scroll bars along the lower and right edges, and a table of rows and columns. The columns correspond to fields of tasks 62, while the rows correspond to individual tasks 62. The top row of each column includes column header labels that describe the fields.

Task Editing Process

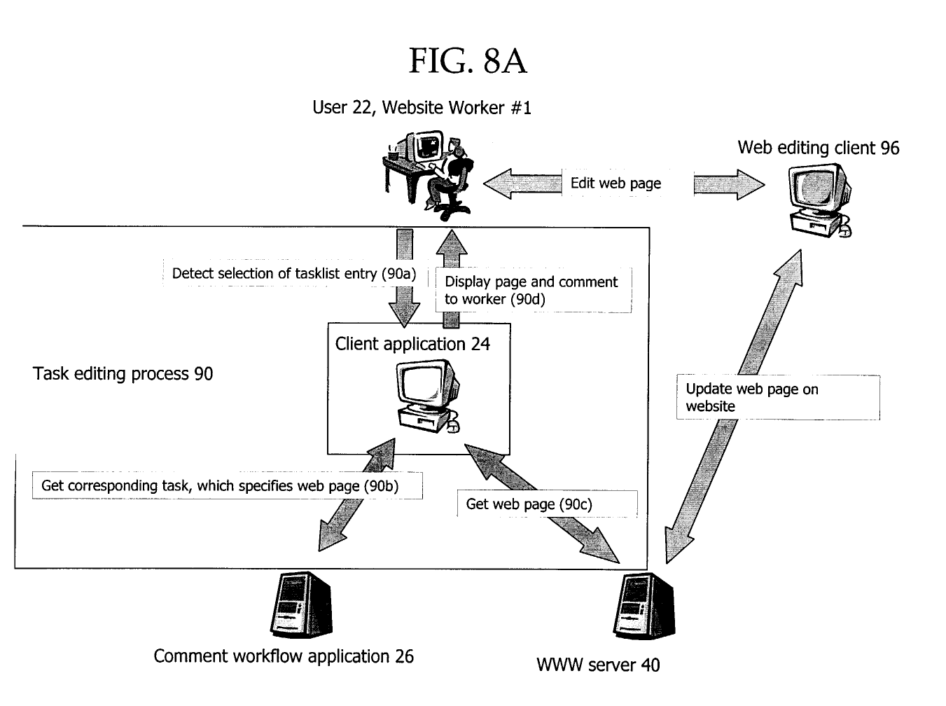

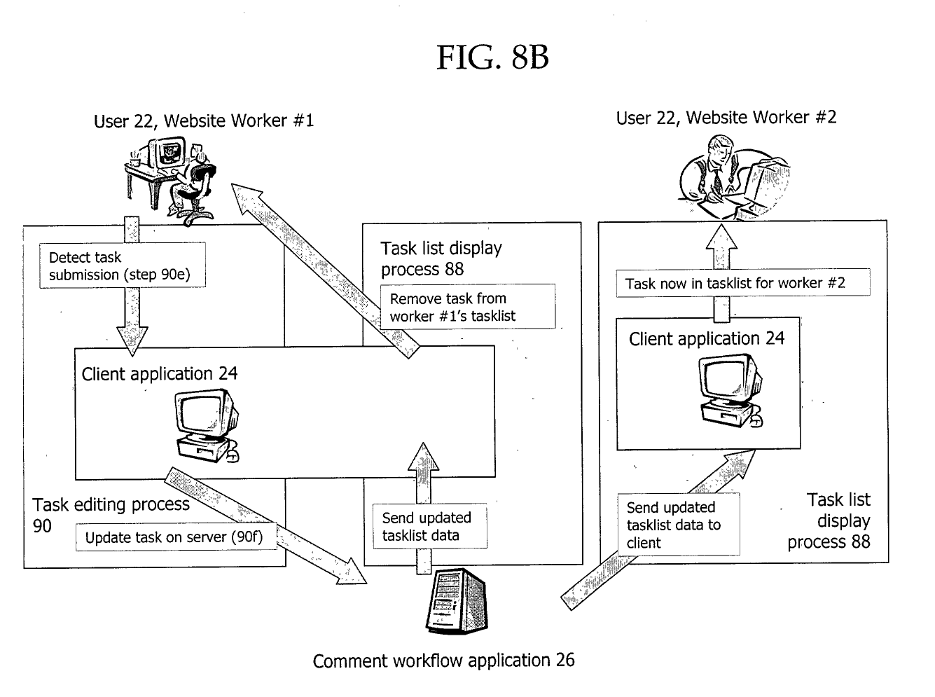

Referring now to FIG. 8A, task editing process 90 operates after a user 22 has logged in to a client application 24 and viewed a current tasklist 82, for instance by using task list display process 88. UI logic 30 presents a user interface to user 22 and mediates between task editing process 90 and actions by user 22. The current user session is associated with a current project 56, which includes a collection of tasks 62.

Task editing process 90 detects the selection of an entry in tasklist 82, for example a double-click by the user 22 on the corresponding row in the control displaying tasklist 82 (step 90a). Task editing process 90 retrieves task 62 corresponding to the selected entry in tasklist 82 from comment workflow application 26 (step 90b). Task 62 has URL 62j, which specifies a URL for a web page 42 served by WWW server 40. Task editing process 90 retrieves web page 42 (step 90c). Task editing process 90 renders web page 42 and opens a dialog for editing task 62 (step 90d). Task editing process 90 renders web page 42 using embedded browser 38 of client application 24. An example dialog is shown in FIGS. 10A-10D.

If WWW server 40 does not provide web page 42, for instance due to network problems, or if web page 42 has changed, task editing process 90 retrieves the snapshot of web page 42 from task 62.

User 22 can use the dialog to inspect task 62, including: the portion of the web page 42 specified by the task 62 in selected area 78c of associated icon record 78; the proposed change, stored in replacement 72j; and the described reason for the proposal stored in discussion contribution 72h of associated history point 72. User 22 can then take action, during task editing process 90 but separate from it, to implement the proposed change to web page 42. For example, user 22 can use a web editing client 96 to access WWW server 40 independently.

When user 22 has finished responding to task 62, user 22 can dismiss the dialog, indicating the next routing 76 for task 62.

Referring now to FIG. 8B, task editing process 90 detects the dialog dismissal (step 90e) and transmits the edited task 62 to comment workflow application 26 (step 90f)

Comment Display Process

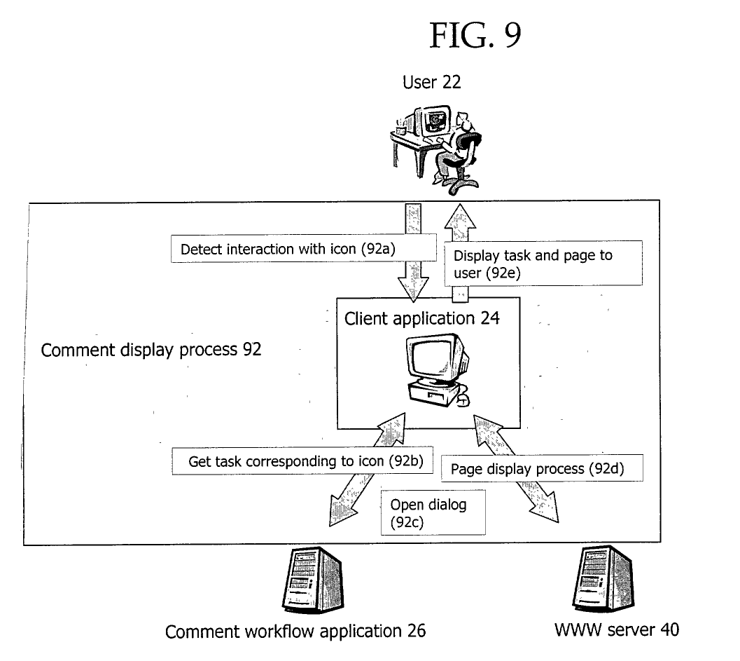

Referring now to FIG. 9, comment display process 92 operates after a user 22 has logged in to a client application 24 and loaded a web page 42, for instance using page display process 84. Furthermore, the web page 42 is referenced by a task 62 for which an icon record 78 is rendered as an icon image 98. UI logic 30 presents a user interface to user 22 and mediates between comment display process 92 and actions by user 22.

Comment display process 92 detects a click on icon image 98 which represents an icon record 78 (step 92a). Comment display process 92 retrieves task 62 corresponding to icon 78 from comment workflow application 26 (step 92b). Comment display process 92 then opens a dialog to display task 62, if needed (step 92c). Comment display process 92 updates the controls in the dialog to reflect the information in the current task 62. Comment display process 92 also uses page display process 84 to render web page 42 (step 92d).

Comment display process 92 presents the dialog to the user and renders the page with icon images 98 corresponding to unresolved tasks (step 92e). The dialog and its controls have the layout described with regard to task editing process 90. An example dialog is shown in FIGS. 10A-10D.

User Interface

Referring now to FIGS. 10A-10E, UI logic 30 renders a main application window 94 that includes a resizable border 94a around its perimeter, a title bar 94b along the top edge of border 94a, a menu bar 94c next to title bar 94b, and a status bar 94d along the bottom edge of border 94a. The interior application of window 94 includes the visible portion of embedded browser 38 as well as optionally concealable components, including toolbars 94e, address bar 94f, a project explorer panel 94g, and a tasklist panel 94h. Embedded browser 38 renders web pages.

Project explorer panel 94g includes scroll bars 94i and a tree control 94k that renders a hierarchy with domain 54 at the top. Domain 54 contain projects 56, which contain content references 60 that themselves can contain recursively nested directory structures of additional tiers of content references 60.

Tasklist panel 94h includes a title bar 94m along its upper edge, scroll bars 94n along its lower and right edges, and a table 94p of rows 94q and columns 94r. The columns 94r correspond to fields of tasks 62, while the rows 94q correspond to individual tasks 62. The top row 94q of each column 94r includes column header labels 94s that describe the fields.

UI logic 30 also renders a comment editing dialog 96 that includes a border 96a around its perimeter, a title bar 96b along the top edge of border 96a, and a task navigation bar 96c next to title bar 96b that includes controls for moving among a collection of tasks 62 and for identifying the current task 62. Next to task navigation bar 96c, comment editing dialog 96 includes a claiming control area 96d and a history bar 96e next to claiming control area 96d.

Claiming control area 96d allows is a specific user profile 66 to take ownership of a task 62 in a step 74 associated with more than one user profile 66. If checked, claiming control area 96d assigns ownership of the task to the current user profile 66 of the current session, removing it from the tasklists 82 of the other user profiles 66. Task 62 is associated with a specific user profile by current user FK 62e.

History bar 96e includes controls for moving among the collection of history points 72 associated with the current task 62, for identifying the current history point 72, and for adding a new history point 72 to the collection.

Comment editing dialog 96 also includes a discussion panel 96f, which includes a text area 96h for browsing, editing, or creating discussion contributions 72h.

Comment editing dialog 96 also includes a tabbed panel 96i, which has tabbed sections for replacement tab 96k, selection tab 96m, captured tab 96n, and workflow tab 96p. Replacement tab 96k includes HTML editing controls for editing current proposed replacement 72j associated with current task 62. Selection tab 96m displays the part of the web page that was selected when the comment was originally created, as stored in selected area 78c of icon 78. Captured tab 96n displays a collection of automatically captured attributes, such as the web page on which the comment was created. Workflow tab 96p renders a picture of the workflow model 58 from the current project 56. The current step 74 for the task is highlighted. If the user displays workflow tab 76 and then uses history bar 96e to walk through the history of the task 62, the highlight will move in the workflow tab 96p, accordingly.

Along its bottom edge, comment editing dialog 96 includes disposition panel 96q, which includes buttons for dismissing comment editing dialog 96. In particular, disposition panel 96q includes a save button 96r, a close button 96s, and one or more routing buttons 96t that each correspond to a permissible routing for current task 62 in its current state at step 74.

FIGS. 10B and 10C show an icon 78 rendered as icon image 98 in an overlay on the visible portion of embedded browser 38. In this example, the task 62 shown in comment editing dialog 96 is related to the icon 78 shown in main application window 94.

When user 22 moves the mouse pointer over icon image 98, UI logic 30 highlights the portion of the web page that corresponds to the value of selected area 78c. The highlight can be change in the background color, for example to yellow or orange. A yellow highlight indicates that UI logic 30 is able to match the portion of the web page to the value of selected area 78c. UI logic 30 uses yellow highlights both for an unchanged web page and for a web page that has changed but not so drastically that UI logic 30 cannot find the values stored in selected area 78c. The orange highlight indicates that the actual web page has changed, and the original locale of the selected portion is still on the page, but that the actual content of the selected portion is gone. In that case, UI logic 30 places the orange highlight over the corresponding locale of the web page.

FIG. 10E shows the proposed replacement of FIGS. 10A and 10B rendered in main application window 94 in a preview mode. Preview button 96u in replacement tab 96k allows user 22 to request the preview mode. Main application window 94 in a preview mode includes tabs 96v and 96w. Tab 96v renders the web page with the proposed replacement performed, that is, with the text of the proposed replacement rendered in place of the portion of the web page specified by the current task. Tab 96w renders the original web page. User can use tabs 96v and 96w to compare “before-and-after” views of the web page, for instance to verify that a replacement that the user has proposed is acceptable, or to better understand the counter-proposal that another user has recommended.

FIG. 10A shows a main application window 94 and a comment editing dialog 96 after a user 22 selects a portion of web page 42 and instructs client application 24 to create a new task 62. FIG. 10B shows main application window 94 and comment editing dialog 96 after a different user 22 selects new task 62 from the displayed tasklist 82. FIG. 10C shows main application window 94 displaying web page 42 with proposed replacement 72j incorporated. FIG. 10D shows main application window 94 after new task 62 has been resolved. For example, in FIG. 10D, icon image 98 for icon record 78 corresponding to new task 62 is no longer rendered.

Discussion and Context

History points 72 store contributions to a discussion of a task. With comment editing dialog 96, user 22 can view these contributions in the context of then-current properties of the task and related entities, such as the associated step within the workflow model, at the time the contribution was made. If user 22 selects a different history point 72 for a rendered task 62, comment editing dialog 96 updates the visual representation of the corresponding step 74 to reflect the context of the new selected history point 72. Context information includes: a proposed replacement of the web page portion associated with the task; the corresponding step within the workflow model; the portion of the web page that the task is associated with; and data about the web page and the computing environment of client device 12.

Replacement tab 96k is described with regard to FIGS. 10A-10D.

User 22 can use comment editing dialog 96 to view a history point 72 together with a visual representation of the portion of a web page associated with task 62. The associated portion can be rendered as interpreted HTML text or as raw HTML source code. Furthermore, 22 can use comment editing dialog 96 to view a history point 72 together with additional data about the context in which the task was created, such as the address of the relevant web page, or the web browser version and the resolution of the client device 12 from which the task was first submitted.

FIG. 11A shows comment editing dialog 96 rendering an example task 62 that has six history points 72, with the most recent history point 72 displayed. A caption on history bar 96e reads “6 of 6”, indicating that the current history point 72 is the sixth for this task, out of a collection of six. Forward-moving navigation buttons are grayed out to indicate that the current history point 72 is the last of the collection for this task. Text area 96h presents discussion contribution 72h for viewing and editing. In FIG. 11, tabbed panel 96i has workflow tab 96p active. Workflow tab 96p renders a visual representation of workflow model 58 for the current task. In the example of FIG. 11, four steps of the workflow model are visible. The lowest of the four steps is rendered with a highlighted border to indicate that it corresponds to the current history point 72, i.e., the sixth.

FIG. 11B shows comment editing dialog 96 rendering the example task of FIG. 11A, but with a different history point 72 displayed. A caption on history bar 96e reads “5 of 6” to indicate the different position, and forward-moving navigation buttons are no longer grayed out, indicating that the new current history point 72 is not the last of the collection for this task. As with FIG. 11A, workflow tab 96p in FIG. 11B renders a visual representation of workflow model 58 with four steps visible. However, the lowest of the four steps is no longer rendered with a highlighted border. Instead, the highlighted border surrounds a different step, indicating that the fifth history point 72 for this task corresponds to a different step than the sixth.

FIG. 11C shows comment editing dialog 96 rendering the example task of FIG. 11A, but with selection tab 96m active instead of workflow tab 96p. In this mode, text area 96h presents discussion contribution 72h for viewing and editing, while selection tab 96m renders HTML text of the selection portion of the web page 42 associated with the task. By default, the checkbox labeled “View Source” is unchecked. In this case, selection tab 96m renders the text stored in selected area 78c as interpreted HTML output. Alternatively, when the user checks the checkbox labeled “View Source”, selection tab 96m renders the text stored in selected area 78c as raw HTML source code.

Referring now to FIG. 10B, captured tab 96n provides statistical and technical information about the web page as it existed when the corresponding history point 72 was created. This includes the domain and URL of the page, the referring page's URL, the last revision date of the comment, and the software version of client application 24. In addition, captured tab 96n lists information about the computing environment of client device 12 when the task was created, such as the platform, the software of the web browser, and the screen resolution of client device 12. Client application 24 captures such information automatically when creating or modifying tasks.

Devices

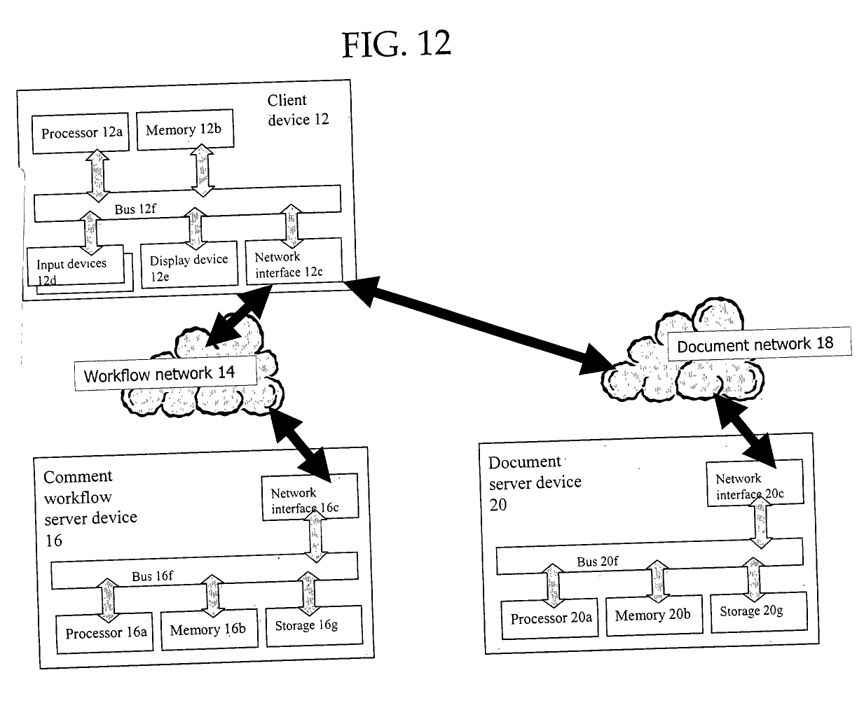

Referring now to FIG. 12, client device 12 includes processor 12a, memory 12b, network interface 12c, input devices 12d, display device 12e, and bus 12f. Processor 12a executes instructions stored in memory 12b. For example, client application 24 is encoded as instructions stored in memory 12b that processor 12a executes. Input devices 12d include a typewriter keyboard and a computer mouse. Display device 12e is a computer screen, for example a cathode-ray tube or an LCD (liquid crystal display) or the like, for presenting a graphical user interface. Bus 12f passes communications between processor 12a, memory 12b, network interface 12c, input devices 12d, and display device 12e. Network interface 12c communicates with workflow network 14 and document network 18.

Comment workflow server device 16 includes processor 16a, memory 16b, network interface 16c, bus 16f, and storage 16g. Processor 16a executes instructions stored in memory 16b. For example, comment workflow application 26 is encoded as instructions stored in memory 16b that processor 16a executes. Bus 12f passes communications between processor 12a, memory 12b, network interface 12c, and storage 16g. Storage 16g is a non-volatile machine-readable and machine-writable storage medium, such as a disk drive or flash memory. Storage 16g stores database 52. Network interface 16c communicates with workflow network 14.

Document server device 20 includes processor 20a, memory 20b, network interface 20c, bus 20f, and storage 20g. Processor 20a executes instructions stored in memory 20b. For example, document server application 28 is encoded as instructions stored in memory 20b that processor 20a executes. Bus 12f passes communications between processor 12a, memory 12b, network interface 12c, and storage 20g. Storage 20g is a non-volatile machine-readable and machine-writable storage medium, such as a disk drive or flash memory. Storage 20g stores web pages 42. Network interface 20c communicates with document network 18.

Alternate Embodiments

A number of embodiments of the invention have been described. Nevertheless, it will be understood that various modifications may be made without departing from the spirit and scope of the invention. For example, workflow network 14 and document network 18 can be the same network.

In the described embodiment, document server application 28 serves web pages 42, and tasks 62 track comments on and changes to the web pages 42. In alternate embodiments, tasks 62 could refer to documents in other formats, for instance: text files, Adobe PDF (Portable Document Format) files; office files such as for Microsoft Word, Excel, PowerPoint and Visio; PostScript files; image and animation files in formats such as JPEG (Joint Photographic Experts Group), Flash, and Windows Media; or, in general, any file storable in an electronic format and transmissible between computers.

In the described embodiment, client application 24 communicates with comment workflow application 26 via XML and HTTP. In alternate embodiments, other network protocols could replace XML and HTTP and carry out similar functions. Furthermore, in the described embodiment, client application 24 and comment workflow application 26 run on different devices, but in alternate embodiments, client application 24 and comment workflow application 26 could run on the same device. Similarly, in the described embodiment, client application 24 and document server application 28 run on different devices, but in alternate embodiments, client application 24 and document server application 28 could run on the same device. Moreover, in alternate embodiments, one or more of client application 24, comment workflow application 26, and document server application 28 could be run on multiple devices with distributed execution.

In the described embodiment, comment workflow application 26 uses CORBA standards for ORB 48, but in alternate embodiments, ORB 48 could use another distributed object standard instead, for example DCOM (Distributed Common Object Model).

In the described embodiment, database 52 is a source of data that is accessible via ODBC, but in alternate embodiments, database 52 could be accessible via a different database interface standard, for example OLEDB (Object Linking and Embedding for Databases). Furthermore, in the described embodiment, database 52 includes tables that represent entities such as project 56, domain 54, workflow model 58, tasks 62, user profile 66, role 68, and history point 72. The tables are one possible logical schema to represent the entities. In alternate embodiments, other underlying configurations of tables, views, or both could represent the entities.

In the described embodiment, a workflow model 58 cannot have more than one terminus step 74. In alternate embodiments, workflow model can have more than one terminus step 74.

Accordingly, other embodiments are within the scope of the following claims.

What is claimed is:

1. A computer-implemented method comprising:
rendering a web page in a browser control in a user interface;
detecting user input that selects a portion of the web page;
presenting a dialog in the user interface that detects user input of a markup to the portion of the web page; and
specifying a collection of users to notify of the markup.

2. The method of claim 1, further comprising:
generating a task entry that specifies the selected portion of the web page, the markup, and the collection of users to notify.

3. The method of claim 2, wherein the task entry also specifies a copy of the web page.

4. The method of claim 2, wherein the task entry also specifies the user that provided the user input.

5. The method of claim 2, wherein the task entry also specifies the approximate time that the user input was detected.

6. The method of claim 2, further comprising:
saving the task entry to a database of task entries.

7. The method of claim 1, wherein the dialog includes a collection of HTML editing controls that detect user input of the markup.

8. The method of claim 1, wherein the dialog detects user input requesting a rendering of the web page that incorporates the markup.

9. The method of claim 1, wherein the dialog renders a plurality of controls corresponding to a plurality of collections of users and wherein the dialog detects user input identifying the collection of users to notify from among the plurality of collections.

10. The method of claim 9, wherein the plurality of controls includes buttons.

11. The method of claim 9, wherein the plurality of controls includes entries in a list.

12. A computer-implemented method for markup workflow management, the method comprising:
loading a web page over a first logical network connection to a web server;
loading markup content for the web page over a second logical network connection to a workflow server different from the web server, where the markup content specifies changes to a target portion of the web page and has a resolution status relative to a workflow model;
if the resolution status indicates the markup content is unresolved, rendering the web page with an icon superimposed on the web page proximate to the target portion; and
if the resolution status indicates the markup content is resolved, rendering the web page with no alteration that indicates the markup content.

13. The method of claim 12, wherein rendering the web page with the icon superimposed includes detecting user interaction with the icon.

14. The method of claim 13, further comprising:
responding to detected user interaction with the icon by rendering a dialog containing the markup content.

15. A computer-implemented method for markup workflow management, the method comprising:
maintaining a database of unresolved tasks in a workflow project, each such task having a reference to a web page, a markup to a target portion of the web page, and an indication of a party responsible for working on the task next;
rendering a task from the database of unresolved tasks in a dialog that includes a display control, such that when a user activates the display control, the web page is rendered.

16. The method of claim 15, wherein the display control includes a list of unresolved tasks.

17. The method of claim 16, wherein the unresolved tasks indicate that the user is the party responsible for working on the tasks next.

18. The method of claim 15, wherein each such task also has a copy of the web page.

19. The method of claim 15, wherein each such task also has a resolution status that indicates whether work on the task is complete.

20. The method of claim 19, wherein if the resolution status indicates that work on the task is not complete, the web page is rendered with an icon superimposed on the web page near the target portion, and otherwise, if the resolution status indicates that work on the task is complete, the web page is rendered with no alteration that indicates the markup content.

21. An article comprising a machine-readable storage medium that stores executable instructions to perform markup workflow management, the instructions causing a machine to:
maintain a database of tasks in a workflow project, each such task having an address of a web page, a copy of the web page, a markup to a target portion of the web page, a resolution status within the workflow project, and an indication of a next party responsible for resolving the task.

22. A computer-implemented method for markup workflow management, the method comprising:
receiving, from a user, input that specifies a contribution to a discussion of a task and that includes a text description of the contribution, wherein the task describes a revision to a document and has a status according to a workflow model that specifies permissible states for the task;
assigning to the contribution a reference specifying the task and a time stamp indicating the approximate time the user input was received; and
passing the contribution to a database for storage.

23. The method of claim 22, wherein the user has a current user profile, and wherein assigning includes assigning to the contribution a reference to the current user profile.

24. A computer-implemented method for markup workflow management, the method comprising:
detecting user input specifying a task to render, wherein the task describes a revision to a document and has a status according to a workflow model that specifies permissible states for the task;
selecting from a database a plurality of contributions made by human users to a discussion of the task, each contribution having a text description of the contribution, a timestamp indicating when the contribution was made, and a reference specifying the task;
for a current contribution among the plurality of contributions, determining a corresponding state of the task based on the timestamp; and
visually rendering the task, the current contribution, and an indication of the corresponding state of the task.
